(19) United States
(12) Patent Application Publication
(10) Pub. No.: US 2007/0220494 A1
(43) Pub. Date: Sep. 20, 2007

(54) A Method of Rapid Software Application Development for a Wireless Mobile Device

(75) Inventor: David Spooner, Berkshire (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: Intuwave Limited, Berkshire (GB)

(21) Appl. No.: 10/578,388

(22) PCT Filed: Nov. 8, 2004
(86) PCT No.: PCT/GB04/04702

§ 371 Date: Jan. 19, 2007

(30) Foreign Application Priority Data
Nov. 6, 2003 (GB) 0325882.9
Dec. 9, 2003 (GB) 0329520.1

(51) Int. Cl. G06F 9/44

(52) U.S. Cl. 717/130

(57) ABSTRACT

A method of rapid software application development for a wireless mobile device, comprising the step of calling modular software elements, that each (i) encapsulate functionality required by the wireless mobile device and (ii) share a standard interface structure and (iii) execute on the device, under the control of a command line interface. Because the elements execute under the control of a command line interface (and hence are command line programs) it is far easier for a programmer to explore the functioning of the elements—in particular how an element responds to a given input.

### FIELD OF THE INVENTION

This invention relates to a method of rapid software application development for a wireless mobile device.

### DESCRIPTION OF THE PRIOR ART

There are many problems when developing software applications for wireless mobile devices (e.g. smartphones, communicators, PDAs etc.). The key problems are:
1. there are a wide range of network connection options, such as Bluetooth, GSM, GPRS, IR and cable, that must be managed by the application
2. mobile devices do not have an adequate user interface for developing software
3. mobile devices typically have small amounts of memory and processing power, relative to laptops and desktop PCs, so the software developed must make very efficient use of resources.
4. Current programming approaches require either very skilled programmers with specialised development software (i.e. using C++ with detailed knowledge of mobile device Oss, e.g. SymbianOS) or make very inefficient use of the restricted resources of the mobile phone (e.g. using Visual Basic on SymbianOS requires 1 MB runtime engine and typical applications are also usually more than 1 MB).

There is no good solution to solving all of these problems. The current main option for addressing problems 1 and 3 is to develop low-level code, in a language such as C++, that directly accesses all of these features on the phone. This is both difficult to learn and slow to develop applications for, because of the detailed knowledge and programming skills required.

The current main option for addressing 2 is to use an emulator for the device running on a PC. This is not as rapid as it could be as the developer has to develop and test his application twice—once on the emulator and secondly directly on the device, and there are always differences in behaviour between the emulator and PC. This is especially true when writing networked applications as the emulator does not have the wide range of network connection options that are available on a phone so more testing needs to be done on the device.

### SUMMARY OF THE PRESENT INVENTION

In a first aspect, there is a method of rapid software application development for a wireless mobile device, comprising the step of calling modular software elements, that each (i) encapsulate functionality required by the wireless mobile device and (ii) share a standard interface structure and (iii) execute on the device, under the control of a command line interface.

Because the elements execute under the control of a command line interface (and hence are command line programs) it is far easier for a programmer to explore the functioning of the elements—in particular how an element responds to a given input. The kind of visibility of functioning is very difficult to achieve using a conventional development methodology.

One or more modular software elements may encapsulate device networking functions. The device networking functionality relates to connectivity over one or more of the following: GPRS, 2G cellular, CDMA, WCDMA, Bluetooth, 802.11, infra-red, IP networking, dial up, modem; HSCSD and EDGE. Previously, being able to systematically explore how device networking operates was very difficult.

One or more of the modular software elements encapsulate general mobile device functionality, such as: call control and handling; PIM functionality; SIM functionality; remote control, including screen scraping and faking key presses; monitoring, including processes, threads, memory and settings; UI, including creating an application where the screen elements are specified from a script; telephony, including monitoring and making calls; file system, including reading writing files and folders, monitoring for changes; database, including structured storage, retrieval, searching and monitoring of arbitrary application data; device personalization, including ringtones, wallpaper and settings.

In one implementation, the element under the control of a command line interface is a TCPIP interface which allows other programs on the device to be run upon receipt of an incoming connection or to make outgoing connections from the device under control of other device based programs. Another element under the control of a command line interface implements a remote command execution protocol. Another element under the control of a command line interface implements a scripting language that allows scripts to be written which use other programs on the device also controlled by a command line interface.

Preferably, a high level language program runs on an application development computer (such as a desktop PC) remote from the device that can send instructions to the or each element on the device controlled by a command line interface; the application development computer is connected to the device over a local point to point IR, Bluetooth, USB, WAN, LAN, SMS or GPRS or any combination of these.

The high level language program is preferably also a command line program that enables IP connections between the mobile device and a further program on the application development computer that implements the same remote command execution protocol as the device. The high level language is not restricted to a single type of high level language, but can be any of the following depending on the requirements of the developer of the software application:
(a) a command line interface;
(b) a scripting language;
(c) a compiled language.

The high level language program can in addition run on the device, to enable re-programming of the device without the need to use a separate application development computer.

Rapid application development is then achieved by enabling device capabilities to be explored by executing the device-based elements controlled by a command line interface from a command prompt displayed on a display of the application development computer using the remote command execution protocol. An output of each command is shown at the command prompt on the application development computer. Rapid application development is further achieved by using scripts which combine the results of several device-based elements controlled by a command line interface in the scripting language written on the device. The script can be composed in a text editor running on the application development computer. Finally, rapid application development is achieved by transferring the scripts to the device and executing them, again using the computer command prompt.

In an implementation (which will be described later in the Detailed Description section) the standard interface structure of a modular software element is the name of the element, a set of command line options, two input streams and two output streams. The modular software elements can be chained together to build complex functionality; they insulate the application developer from the specifics of the operating system of the device by requiring the application developer to understand the type of functionality to be deployed and not the specific operating specific code needed to implement that functionality using the operating system.

The device may run a command interpreter and the application development computer then runs a command execution shell.

In another implementation, the modular software elements execute on the device in the context of an identity and associated permissions. An identity server (located on the device) with secure permissions provides and controls the identity and associated permissions.

In one implementation, modular software elements, called pipe processors, are combined in a way that significantly reduces the time it takes to develop networked applications for mobile devices.

Pipe processors are stand alone modules that encapsulate a range of mobile device functionality. Pipe processors are written efficiently in a software code suitable for the phone operating system, such as C++. These pipe processors are all called from a standard interface structure, comprising the name of the pipe processor and a set of options. The results of the pipe processor are returned to the calling element using a standard output and standard error.

Rapid networked application development is facilitated because:
All of the pipe processors have the same type of interface that can be called from a command-line interface, or other high-level language. This provides the developer with the means of solving the network management problems of 1 but without having to learn the details of a specific network interface or program in a low-level language such as C++.
All of the pipe processors can be executed on the device remotely from the PC, so providing the developer with a good user interface for development but without having to develop software first on a emulator and then for the device.
The modular architecture of the pipe processors means that modules can be included or removed as necessary. This means that software can quickly be developed that also makes efficient use of the restricted resources on the mobile device, so solving problem 3. Other rapid development approaches for mobile devices, such as using high-level languages such as Visual Basic, require large run-time components and hence consume large resources on the mobile device.

The problem of rapid networked application development and reconfiguration has been around for some time as mobile devices, such as PDAs, have been around for many years. Current approaches to this problem, such as using Java MIDP, cannot however fully exploit the network features of the mobile device as they are constrained by the high-level interfaces required to make the development quick and easy. Also, many of the current approaches rely on the use of emulators on the PC. The present invention can complement Java MIDP to overcome these limitations. As noted earlier, the present invention hence solves the problem of rapid networked application development and reconfiguration, as all of the pipe processors can be called either from command-line, scripts, or other programming languages. Hence, required functionality can be quickly prototyped using scripting to prove the functionality, before being codified into a programming language for the application.

There are three significant further advantages to the present invention:
1. Enables programming by non-skilled programmers. Using the set of pipe processor components that can be called from both a command-line interface, scripting language and variety of programming languages enables both phone users with no programming experience to ‘program’ software on the phone as well as advanced software developers, all using the same components. This enables software to be modified by unskilled programmers to adapt it to uses that were not originally envisioned by a programmer, just by modifying the script on the phone. This can be used as a means of enabling non-skilled programmers to modify applications for their own use, or to quickly prototype and test an application that can be handed to a skilled developer for turning into a complete networked software application for mobile devices.
2. It allows someone to modify a software application when all they have is a mobile device, for example when they are on the train. Software can be developed from a PC, with a link to the mobile device. However, if the application is scripted on the mobile device then when you are away from your PC, the script can be quickly modified to create a different application, without the need to compilers, debuggers, emulators and the other development tools required for standard PC-based software development.
3. Provides a single interface from a wide range of programming languages, including command-line and scripting interfaces, to mobile devices running a wide range of operating systems. Hence, a programmer can choose whatever language they like to develop the software, and does not have to learn different interfaces for different mobile devices. This is similar in concept to using Java MIDP as a basis for writing portable applications for smartphones. However, using Java MIDP it is not possible to write good networked applications for mobile devices as Java MIDP standard does not allow access to the necessary networked features on the phone. This can be achieved by extending the MIDP programming interface with additional mobile-device specific interfaces, but this requires the developer to understand the different interfaces for each phone. The proposed framework eliminates this problem by providing a common interface to the low-level networking and other phone features that is common across different mobile device operating systems.

In another aspect, there is software application developed using the method of rapid software application development described above. This software application may be initiated or controlled from a remote application development computer and may then be is accessed or controlled by the remote application development computer in a secure fashion. The software application may also run stand-alone on the device without any initiation or control from a remote application development computer.

In another aspect, there is a method of rapid software application development for a wireless mobile device, comprising the step of calling modular software elements, that each (i) encapsulate networking functionality required by the wireless mobile device and (ii) share a standard interface structure and (iii) execute on the device, using a high level language program. The high level language mat be
(a) a command line interface; or
(b) a scripting language; or
(c) a compiled language.

In terms of interaction with physical hardware, the modular software elements execute on the CPU of the mobile device. Further, because the elements execute using a command line interface, the interface necessarily has to be shown on a computer display.

### BRIEF DESCRIPTION OF THE DRAWINGS

The invention will be described with reference to the accompanying drawings, in which:

FIG. 1 is an example configuration of a system (‘mrix’) for rapid application development in accordance with the present invention;

FIG. 2 shows a possible mrix architecture for an implementation of the present invention;

FIG. 3 shows how mrix consists of a number of elements which can be used to run commands over local links (IR, Bluetooth and USB) as well as via a remote relay (TCP/IP, GPRS).

### DETAILED DESCRIPTION

The purpose of the invention is to facilitate rapid develop of networked application software for mobile devices. The invention is implemented in technology called mrix from Intuwave Limited. mrix is a wireless software platform designed to significantly reduce the time to market in producing solutions involving smartphones by:—
reducing the learning curve and therefore opening up development to a larger community of developers
providing network OS like facilities allowing smartphones to be treated like shared network components
providing critical “building blocks” which encapsulate complex smartphone functionality.

mrix includes a platform agnostic remote command execution environment for smartphones. A command interpreter interfaces to a smartphone through a set of commands or “pipe processors”. These are small stand-alone modules written in C++ or scripting languages that encapsulate a range of smartphone functionality. Appendix 1 reproduces sections from an mrix guide and Appendix 2 is a list of some of the available pipe processors. Appendix 3 is a guide for developers wishing to write pipe processors for Symbian OS. Appendix 4 describes how mrix commands (including both C++ pipe processors and scripts) should be written and how they should operate. Appendix 5 outlines a number of opportunities for employing mrix to assist Symbian OS smartphone manufacturers improve the quality and quantity of product testing.

Device resident mrix pipe processors (prefixed with “mr”) are provided which facilitate the control and management of multiple bearers (GPRS, SMS, Bluetooth, MMS, WiFi etc); device peripherals (such as barcode readers, pens, printers, GPS etc); other devices and servers; and network billing. Pipe processors can be “chained” together to build more functionality. These building blocks allow fast and iterative development of mobile solutions. The use of scripting languages opens up development to a much broader community of developers.

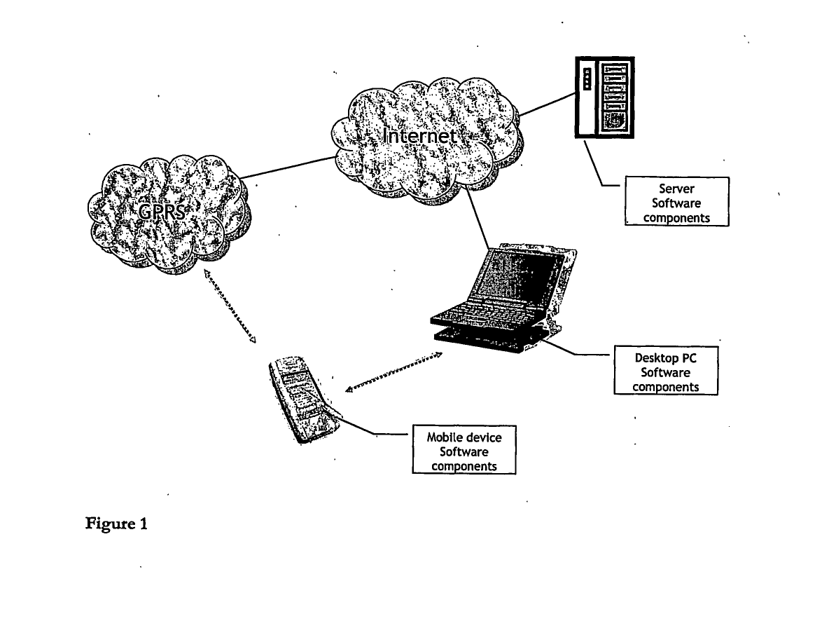

An implementation comprises software resident on the different computing devices (including mobile devices) connected to the network, such as a smartphone, desktop PC and server, with an example configuration shown in FIG. 1.

Software components are required on all of the different elements in the network to facilitate rapid application development and deployment. This is illustrated by the following example for developing a networked application on the mobile device that enables a user to make full use of an enterprise CRM system for better customer relationships. To do this, software must be developed on the mobile device that can connect to an enterprise server, that implements the CRM system and manages all of the customer interactions for the enterprise. The mobile device must be able to connect both over a wide area connection to the server (such as over GPRS) as well as through a faster local connection through a broadband wireless link through the PC. The limited user interface of the mobile device also means that the mobile device must connect easily with the desktop PC to allow the user to take advantage of the large screen and keyboard of the desktop PC when the user is sitting at his or her desk.

The traditional means of developing such an application would be to develop the software on the desktop PC using appropriate development tools, such as an IDE, and to run and test the application on an emulator on the desktop PC. Once the software is successfully running on the emulator then it can be transferred to the mobile device, where it needs to be debugged again. This approach is often fine for non-networked applications as there is little difference between the emulator and PC. However, for networked applications the emulator does not have the range of network connections available on the mobile device so development is much more difficult. This problem is overcome in this invention by having components on the desktop PC (which term includes Windows, Macintosh, Linux or any other operating system powered computers) and mobile device that can be executed over the network connection, either locally over a local wireless link, such as Bluetooth, or remotely over GPRS (or any other connection to the phone such as SMS). Hence, the developer can proceed in a much faster way for development of the networked application as follows:
1. The developer chooses which of the modular set of mrix pipe processor components will be used for the application.
2. The developer tests how the chosen pipe processors will be used from the command line.
3. A simple script can be put together to put these together into a complete application running on the phone, again running remotely from the desktop PC.
4. Connectivity components on the PC, such as mRouter, which may be part of mrix, are used if networked connectivity is required to, or routing through, the desktop PC from the mobile device. See PCT//GB2002/003923, the contents of which are incorporated by reference, for more details on mRouter.
5. Connectivity components on the server are used if the server needs to connect to the phone. This is required as the phone's IP address is not visible to the outside world so cannot be contacted by the server. Hence, the Relay server is required that is visible by both the phone and back-office server, to enable networked communication to the server.
   mrix Architecture

mrix is designed around a command interpreter running on a smartphone and a command execution shell running on a remote PC or other suitable platform. Pipe processors can be invoked remotely (like Unix commands) from a desktop PC via m-Router™ or a remote server via a Relay. This not only allows development and debugging of an mrix solution to be carried out from the convenience of a desktop PC but also allows smartphone components to be shared at runtime over networks.

Some pipe processors are mandatory and are considered core to the system. Examples include mrEvent or mrAt which are used to start and stop processes based on events. A set of optional pipe processors are also supplied which can be removed from the runtime, if required, to minimise the memory footprint. Custom pipe processors can also be built in C++ or LUA Script and templates are provided for this.

mrix Solution Examples

See “mrix Features at a Glance” for more information on components used.

Monitoring Spare Parts Availability

| | |
|---|---|
| Description | Keeping an accurate inventory of the levels of spare |
| | parts carried by a field engineer is difficult. By |
| | combining low cost Bluetooth peripherals such as pen |
| | barcode readers with the advanced connectivity fea- |
| | tures of smartphones, mrix enables field service |
| | engineers to keep a tab on van stock levels and |
| | automatically enquire if missing stock items can be |
| | picked up from other vans in the area. |
| mrix | mrBluetooth is used to easily manage the connectivity |
| Solution | between a smartphone and a bluetooth enabled barcode |
| | pen. When the engineer needs a part, he/she “swipes” |
| | the product barcode from a parts catalogue. A persis- |
| | tent inventory of parts is maintained on the device |
| | using mrStorage. Automatically, the smartphone indi- |
| | cates to the engineer the available stock on the van. |
| | If the part is not available, an SMS is created via |
| | mrMessage and sent to other engineer's smartphones. |
| | Using mrWatchFile on the recipient's smartphones |
| | to trigger on receipt of a specific SMS message, the |
| | inbound SMS causes an inventory check to be carried |
| | out. If the remote engineer's phone indicates that the |
| | part is available on the van, an SMS is automatically |
| | sent back to the original engineer. On receipt of the |
| | SMS, a prompt automatically displays on the smartphone |
| | (mrPrompt) which informs the engineer that the part is |
| | available and supplies the phone number of the engineer |
| | with that part. The process can be further enhanced to |
| | only inquire of stock availability from engineers who |
| | are local using mrSim and the current cell-id. |
| Components | Relay, mrBluetooth, mrStorage, mrMessage, mrWatchfire, |
| Used | MrPrompt, mrSim |

Sending an SMS from a PC

| | |
|---|---|
| Description | Entering text messages can be tedious on a small |
| | smartphone. With mrix on the device, it is |
| | straightforward to build an application which would |
| | allow text messages to be composed from a Bluetooth |
| | connected PC and sent via the phone. |
| mrix | Using m-Router and mrCmd, the smartphone is connected |
| Solution | to the PC via Bluetooth. After authentication of the |
| | user (identities), a list of contact names and phone |
| | numbers is retrieved from the phone (mrContacts) and |
| | displayed on the PC. The user selects one or more |
| | contacts on the PC, enters the body of the text message |
| | and presses “Send SMS”. PC application calls |
| | mrMessage with the data and the text message is |
| | automatically sent from the phone. |
| Components | m-Router, mrCmd, Identities, mrContacts, mrMessage |
| Used | |

Remote Smartphone Support

| | |
|---|---|
| Descrip- | Providing support to remote smartphone users can be a |
| tion | problem. mrix allows an operator with a remote PC (and |
| | permission from the end user) to take full control of a |
| | smartphone connected over a cellular network. |
| mrix | The end user runs a support application on the |
| Solution | smartphone which automatically connects to a network |
| | hosted Relay over the cellular network. The operator |
| | also connects to the Relay via an application on their |
| | PC. Once all parties are connected, the operator can |
| | connect directly to the smartphone. Using mrKeyboard |
| | and mrImage, a real-time moving image of the |
| | smartphone's screen and a working visual image of the |
| | smartphone's keypad are displayed on the operator's |
| | screen. Using mrPrompt, the operator is able to ask |
| | the user for permission to carry out certain tasks |
| | on the device. Using mrPS, the operator is able to |
| | see a list of the applications currently running on |
| | the smartphone. Using mrLaunch and mrShutdown, the |
| | operator is able to start and stop running processes |
| | and restart the phone remotely. Using mrSysInfo, |
| | the operator is able to see information about the |
| | smartphone including available memory, storage types |
| | etc. All tasks are completed remotely with the user |
| | involved throughout the operation. |
| Compo- | Relay, Identities, mrKeyboard, mrImage, mrPrompt |
| nents | |
| Used | |

| | | |
|---|---|---|
| Need | Feature* | Benefit |

mrix Features at a Glance

| | | |
|---|---|---|
| PC | m-Router ™ | Provides IP over serial link. Allows full control |
| Connectivity | mrCmd | of device from connected PC over Bluetooth, |
| | | IrDA, cable etc. |
| Operation | Relay | Connects devices and server processes over |
| over remote | | firewall protected networks where devices are |
| connection | | not “visible”. Allows device on GPRS network |
| (GPRS, WiFi | | to be discovered by other devices or services |
| etc) | | and facilitates “push”. |
| Security | Identities | Users (or services) have to supply credentials to |
| | | access commands on the device. |
| Data Storage | Sky Drive (remote) | Important data captured at the smartphone can |
| | mrStorage (local) | be sent to an always available virtual storage |
| | | device on the network or in the device. Data |
| | | stored can be processed at a later time. |
| Messaging | mrMessage | Easy to monitor and manage the device's |
| | | message centre. |
| Event Driven | mrWatchfire, mrAt, | Trigger actions when certain situations are met. |
| Operation | mrEvent | E.g. run script on receipt of specific SMS/MMS |
| | | message. Also schedule to operations run at |
| | | specified times. |
| Connectivity | mrBluetooth, | Create and manage connections over multiple |
| | mrObex, mrTCP, | bearers, examine and process data sent and |
| | mrThroughput | received and measure network performance. |
| | | Send files via OBEX. |
| Phone | mrSysInfo | Returns device information including available |
| Information | | drives, free space, format etc. |
| Network | mrSIM | Returns network information such as IMEI, |
| Information | | current cell-ID, area and Mobile Network |
| | | Operator. |
| Remote | mrImage, | Allow device screen to be projected to a |
| Control | mrKeyboard | connected PC and the keyboard of the |
| | | smartphone to be controlled remotely. |
| File | mrFile | Easily manipulate the smartphone file system. |
| Manipulation | | |
| Runtime | mrPs, mrMr, | Query, start and stop processes on the |
| Control | mrBoot, | smartphone; start applications automatically on |
| | mrShutdown, | boot and shut down a device. |
| | mrLaunch | |
| Data Capture | mrPrompt | Capture data from the user on smartphone via |
| | | pop up dialog box. |
| PIM Data | mrContacts, | Full search, add, edit and delete of smartphone |
| Access | mrAgenda | PIM data including contacts, calendar and |
| | | memos. Possible to manipulate vcards, |
| | | minivcards, uuids, speed dials, groups etc. |

Specifications

| | | |
|---|---|---|
| Supported | Smartphone | Symbian OS v6.1, 7.0, 7.0s |
| Operating | | Microsoft PocketPC Smartphone Edition |
| Systems | | |

| | |
|---|---|
| Relay, mrCmd | MacOS X, Linux, Windows ME, 2000, XP |
| | Home and Professional |

Feature List

The core mrix system contains a number of elements some of which are deployed on the smartphone:

mrcmd: mrcmd consists of two elements, a command interpreter for smartphones and a remote command execution shell. The command interpreter currently runs on Symbian. The remote command execution shell runs on Windows, Mac OS X and Linux.

m-Router®: Command-line interface to Intuwave's existing m-Router® product which handles local connection management on Symbian OS smartphones. m-Router® operates over Serial, Bluetooth, USB and IrDA bearers.

mrElay: mrElay consists of both a command-line interface to Intuwave's remote relay server and the relay server itself. Currently the relay server can be accessed from the smartphone via GPRS or via a WAN proxied through a local m-Router® link.

pipe processors: Pipe processors are small self-contained modules that encapsulate smartphone functionality. A small number of pipe processors that manage event handling and file access are in the mrix core.

script engine: A powerful and compact (60 k) LUA 5.0 scripting engine is included on the smartphone to allow a developer to readily combine pipe processor functionality directly using scripts. Included with the scripting engine are a number of core mrix scripts that powerfully combine existing pipe processor functionality.

mrix Reference Manual: HTML pages that explains how to use all the existing core pipe processors. There are also instructions on writing new pipe processors as well as m-Router® and mrcmd functionality. documentation and example scripts detailing is included.

We have a range of additional pipe processors that extend the core functionality of the system. These pipe processors can be readily added to an mrix system to enhance its capabilities.

The mrix Advantage

Areas of Application

mrix technology is directly applicable in a wide range of applications where remote control of a smartphone device is important:

Testing: mrix enables full automation of system, functional, acceptance, regression and interoperability tests.

PIM applications: mrix enables rapid development of PC Connectivity PIM applications through script-accessible toolkits.

Benefits

mrix offers numerous benefits to smartphone manufacturers and phone network operators.
Speed of development: mrix development is done in rapid iterations by evolving scripts rather than coding against APIs. This significantly speeds up the development lifecycle.
Cost: Since mrix functionality is script-based, the cost of development as well as the cost of maintenance and enhancement of functionality is significantly reduced.
Cross-platform: mrix offers full cross-platform support for smartphones. When combined with a cross-platform toolkit, server applications can be built to run across different PC Operating Systems.

### APPENDIX 1

MRIX—Getting Started Guide

MRIX Overview

mrix is a platform agnostic wireless network operating system. It is designed to allow rapid cross-platform development of a wide range of mobile applications both on and between smartphones, personal computers and servers. It consists of a powerful set of command-line driven tools which can be built upon and combined into sophisticated PC applications using scripting languages. In addition, mrix can be used to script applications that can be executed on the smartphone itself.

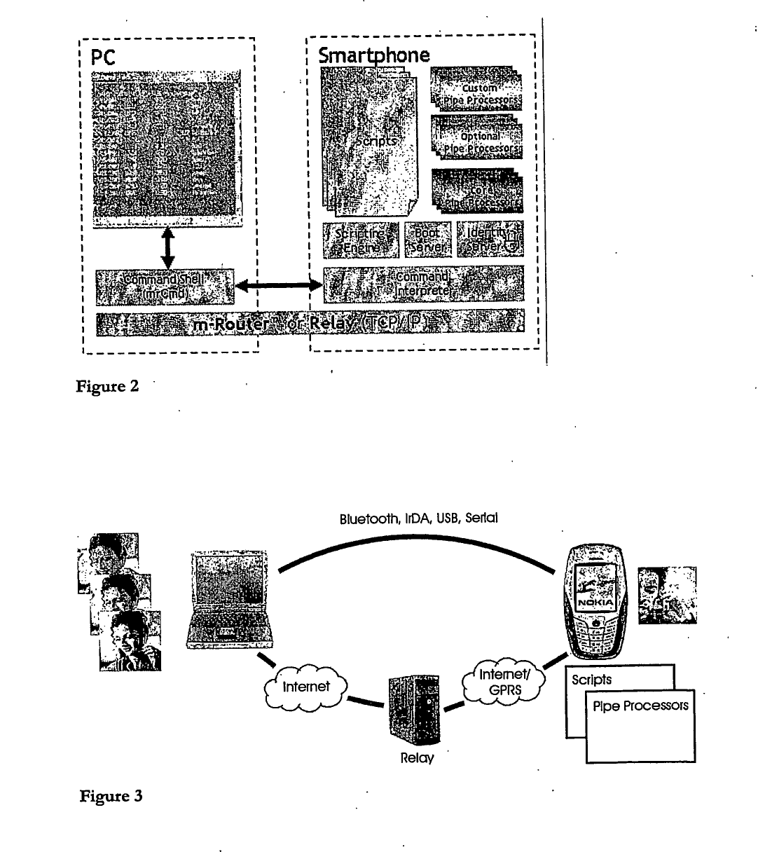

FIG. 2 shows a possible mrix architecture.

mrix consists' of a number of elements which can be used to run commands over local links (IR, Bluetooth and USB) as well as via a remote relay (TCP/IP, GPRS) as shown in FIG. 3.

There are several key elements of the architecture:
m-Router: Bearer connection agent. m-Router consists of a number of both PC and smartphone components. It enables communication between a smartphone and a PC over a variety of short-link bearers: IrDA, Bluetooth, USB and Serial.
Relay: The relay, mrElayD (the ‘D’ stands for daemon) allows remote access from a PC to a smartphone via GPRS. The PC and smartphone both connect to the relay in order for communication between them to occur.
Identity server: All commands are run, whether locally or remotely, on behalf of an “identify” (person or system). Different identities may be configured to run commands with different results.
Boot server: Handles mrix events to be started on smartphone reboot
Command interpreter: A command interpreter module, rshd, runs on the smartphone and is normally set up to start up on boot
Command shell: A command shell, mrcmd, runs on the PC. The shell currently runs on Windows but will soon be available on Linux and Mac OS X. Programs and scripts can be written for the PC that communicate and interact with mrix components on the smartphone.
Lua scripting engine: Scripts written in Lua can be run on a smartphone. A number of useful scripts, e.g., SMTP and FTP clients, are provided with the release.
Pipe processors: Discrete smartphone modules that can be accessed through the mrix command environment to provide access to a range of smartphone functionality.
   Prerequisites

Usage of mrix requires the following hardware and software:
PC with IrDA or Bluetooth support
Microsoft Windows 2000 or later
m-Router
mrix
Smartphone (Nokia 7650, 3650, 6600, N-Gage, SonyEricsson P800)
   Using MRIX
   m-Router—Connecting to the Smartphone

On the PC open a command prompt and type
>mrouter -h

This command displays the help for m-Router. All commands have a help option that can be invoked via -h or the long form --help.

To search for smartphones to connect to type
>mrouter -c search-devices

This command option searches for all the Bluetooth devices in the locality.

The first four columns listed are an arbitrary ordinal listing number used to represent the device, the UID (for smartphone devices this will be the IMEI number—in this example it is only shown for device 8), the Bluetooth address and the Bluetooth friendly name (assigned by the user of the device).

Find your smartphone from the resulting list of devices then connect to the smartphone by typing the following command at the command prompt
>mrouter -c connect-device -d <Bluetooth device name>

For example if your smartphone has a Bluetooth name of Nokia7650 then the command would be
>mrouter -c connect-device -d Nokia7650

You will see the screen of the m-Router icon in the system tray turn from red to blue.

You may find that for development purposes using the ordinal resulting from the “search-devices” is the most convenient. You can connect to a smartphone using a variety of addressing schemes. The “-d” option takes the form <schema>:<id>. Schema can be one of N, IMEI, BTADDR, BTNAME, ANY. If not present, schema is assumed to be ANY. N will match against the listing number next to each device returned by list-devices or search-devices. IMEI matches the UID field. BTADDR matches Bluetooth address. BTNAME matches device BT friendly name. ANY matches all the above. So, it is possible to connect to a device in various ways thus:

>mrouter -c connect-device -d 8
>mrouter -c connect-device -d IMEI :xxxxxxxxxxx
>mrouter -c connect-device -d BTADDR :xxxxxxxxxx
>mrouter -c connect-device -d SJC xxxxxxxxx

To disconnect from the smartphone, type
>mrouter -c disconnect-device -d <Bluetooth device name>

You can Also Type
>mrouter -c disconnect-device -d.
   where a period stands for the currently connected device or the first connected device if more than one device is currently connected.
   mrcmd—Controlling the Phone from the PC

mrcmd is a PC side program that allows you to run pipe processors and scripts on the smartphone. Before running pipe processors and scripts on the smartphone it is necessary to set up the requisite level of security for your mrix setup. This is done by setting the mrcmd environment variable. At present, identity configuration information is stored in the \system\mrix\identity.ini file on the smartphone. A CTO identity has been set up in this file with a password of GOOD. You should use this identity for playing with the mrix system. This can be done from the DOS command shell as follows:
>set mrcmd=-i CTO -a GOOD

Alternatively you may wish to set this permanently thus:
Right click on ‘My Computer’ on your desktop and select ‘Properties’.
Select the ‘Advanced’ tab.
Click the ‘Environment Variables’ button.
Click the ‘New’ button in the ‘System variables’ list.
Enter ‘MRCMD’ into the ‘Variable’ field and ‘-i CTO -a GOOD’ into the ‘Variable Value’ field.
Click OK three times to save the change.

Once security has been set up, you will need to start up the remote shell daemon, rshd, on the smartphone. You should only have to do this once the first time you run mrix on the smartphone. Thereafter, rshd will be automatically started at boot using the mrix boot server. To run rshd, you need to open the mrix application on the smartphone and execute the first command in the list box which should be:

mrtcp

--accept --local 3011 --run “rshd --run”

The mrix application is a simple way of running commands and scripts on the smartphone. To invoke another command from mrix just simply overwrite an existing command line (and any necessary parameters).

Now you are ready to try running an mrix command using mrcmd over an existing mRouter connection. You may try out any of the wide range of existing pipe processors; mrps and mrfile will be described here.

Connect to the smartphone using m-Router.

To view all the processes running on the smartphone, type
>mrcmd . “mrps -l”

mrcmd tells the smartphone (in this case denoted by a period which means the currently connected device but you can be explicit and specify the Bluetooth name) to run the mrps pipe processor with the -l option. Notice that the command is enclosed in double quotes.

To get help on mrps from the command line, type
>mrcmd . “mrps -h”

To send a file to the smartphone, type
>mrcmd . “mrfile -w c:\system\default.car” < c:\mrix\bin\default.car

This command redirects a file (c:\mrix\bin\default.car) to the smartphone. The ‘-w’ option specifies where on the smartphone the file should be written (c:\system\default.car).

To delete the file from the smartphone type
>mrcmd . “mrfile -d c:\system\default.car”

To get help on mrfile from the command line type
>mrcmd . “mrfile -h”

Lua scripts can also be invoked using mrcmd. To get help on running lua scripts from the command line, type
>mrcmd . “luarun -h”

Create a script file called test.lua and copy and paste the text between (and not including) the chevrons to the file

>>>>>>>>>>>>>>>>>>>>
#lluarun
mrix.write(“Hello, World!\n”)
-- run the mrprompt pipe processor
-- mrix.run runs other scripts and pipe processors and has the form
-- mrix.run(command, command parameters, [optional input])
res = mrix.run(“mrprompt”, “-t YESNO -p \“Need help?\””)
mrix.write(“Result = “..res..”\n”)
>>>>>>>>>>>>>>>>>>>>

Lua scripts can be run on the smartphone in one of two ways:
by streaming a lua script to the smartphone
by running a lua script that resides on the smartphone.

To stream the script to the smartphone, type
>mrcmd . “luarun -“ < test.lua

The script will print, “Hello, World!” at the command line. By this method the script does not have to be resident on the smartphone.

To run the script from the smartphone, first write the script to it.
>mrcmd . “mrfile -w c:\system\mrix\test.lua” < test.lua

To run the script, type
>mrcmd . “luarun c:\system\mrix\test.lua”

The result is the same as running the script by the first method.

Lua can be invoked interactively as in the following example thus:

>mrcmd. “luarun”
>mrix.write(“Hello, World!”)
>q

More on Scripts

There are two ways to run a Lua script on a smartphone independent of interaction with a PC.

The first is to invoke it using the mrix application. Simply type the name of the script in the Cmd field and any parameters for the script in the Params field and select Run.

The second is to have the script run when the smartphone is turned on. To do this you have to setup an event that loads the script into the boot file of the smartphone:
>mrcmd . “mrevent -a -n runmyscript -e BOOT -c luascript.lua”

This command adds (-a) a boot command (-e BOOT) to the boot file of the smartphone to run a script (-c luascript.lua) when the smartphone is turned on. The event is given a name (-n runmyscript) that acts as a handle such that it can be removed from the boot file thus:
>mrcmd . “mrevent -d -n runmyscript”
   Identities

All mrix smartphone scripts and pipe processors are run, whether locally or remotely, under the permission of an identity. An identity consists of a username, password and a set of permissions governing which scripts and pipe processors may be run under that identity. The identity file, identity.ini, is located in the \system\mrix directory on a smartphone.

So far we have run commands via mrcmd using the user, CTO (which has full permissions for all commands). If a smartphone is setup to run a script when it boots then the default identity it will use will be “Guest” which has minimal permissions. The script will therefore be limited in the mrix commands that may be run. To do anything useful the identity must change so that the script may take on more permissions. Edit the lua script file you created earlier. Copy and paste the text between (and not including) the chevrons to the file. Then use mrfile to send the script to the smartphone and run it using the mrix application. In mrix select Options|Run, enter “test.lua” into the Cmd field (make sure the Params field blank) and select Run. You will be presented with a prompt to which you may select yes or no.

>>>>>>>>>>>>>>>>>>>>>>>
#lluarun
-- save the current identity, in this case, Guest
old_id = mrix.getcurrentidentity( )
-- make a new identity handle using the CTO username
new_id = mrix.makenewidentity(“CTO”, “GOOD”)
-- use this newly created identity to run the following commands
mrix.setcurrentidentity(new_id)
mrix.write(“hello, world!\n”)
-- run the mrprompt pipe processor
-- mrix.run runs other scripts and pipe processors and has the form
-- mrix.run(command, command parameters, [optional input])
res = mrix.run(“mrprompt”, “-t YESNO -p \“Need help?\””)
mrix.write(“Result = “..res..”\n”);
-- restore the saved identity
mrix.setcurrentidentity(old_id)
-- release the new identity to free up resources
mrix.releaseidentity(new_id)
>>>>>>>>>>>>>>>>>>>>>>>

### APPENDIX 2

Pipe Processors

| | |
|---|---|
| mrAgenda | provides an interface to the agenda database |
| mrAt | schedules commands to run at given times |
| mrBluetooth | provides access to a range of Bluetooth services |
| mrContacts | provides an interface to the contacts database |
| mrElayd | establishes a connection to a relay server |
| mrEvent | sets up and fires events (commands) |
| mrFile | performs basic file and directory operations |
| mrImage | captures a single image or stream of images from |
| | the device |
| mrKeyboard | simulates keyboard character entry |
| mrLaunch | starts applications, lists installed/running applications |
| mrMessage | view/delete messages, send SMS, watch inbox |
| mrMr | retrieves information regarding other pipe processors |
| mrObex | turns a device into a Bluetooth OBEX beaming client |
| mrPrompt | prompts the user with simple questions |
| mrPs | process and thread status management |
| mrShutdown | shutdown, reboot or see boot status of device |
| mrSim | retrieves sim related information |
| mrSky | stores data on an ‘always available’ storage area on |
| | the internet |
| mrStorage | allows data to be stored on the device |
| mrSysinfo | returns system information |
| mrTcp | Establishes TCP/IP connections |
| mrThroughput | tests throughput to and from phone |
| mrWatchfire | runs commands when watched resources change |

### APPENDIX 3

Developing Symbian Pipe Processors

1. Introduction

This section is intended to operate as a guide for all developers wishing to write Symbian pipe processors. It covers the basics of getting started using the mrix pipe processor template and also discusses some of the common patterns that may be encountered during pipe processor development.

2. What is a pipe processor?

A pipe processor is a smartphone based module that encapsulates a logically related set of smartphone functionality. They are so named because they abstract all their input and output through an mStream derived interface. That is, they essentially present their functionality through a command line interface. For example, the mrContacts pipe processor abstracts all aspects of Contacts management on a smartphone. If mrContacts is invoked with a -l option, it returns a list of all contacts. If it is invoked with a -p option, it expects a file of contact information which it will use to update the Contacts database on the smartphone.

On Symbian, pipe processors create a single instance of a CmStreamProcessorInstanceGroup derived class which in turn can be used to create any number of CmStreamProcessorInstance derived instances to manage specific tasks. Typically a separate CmStreamProcessorInstance would be created for each significant command line option. Pipe processors can be designed as stand alone entities or can internally invoke other pipe processors using an instance of the CPipeProcessorRunnerContainer class.

Pipe processor capabilities can be leveraged most powerfully through the mrix framework which is the focus of this document. Within that framework, they can be invoked directly either through the mrix mrcmd remote shell interface or via LUA scripts running on the device. In general, it is a good idea to design pipe processors to be logically self-contained modules responsible for distinctly separate aspects of smartphone functionality. In other words, pipe processors should be kept as “orthogonal” as possible and designers should avoid attempts to shoehorn different sorts of responsibility into a single module.

Common features of all pipe processors on Symbian:

1. Polymorphic DLL with single export that returns a pointer to a pipe processor group. For mrContacts this is:

CmStreamProcessorInstanceGroup* CmrContactsGroupCreatorFunction(const mStreamMan::FixedString&aName)

2. UID 1 is 0x1000AF70

3. Responsibility for some discrete aspect of smartphone functionality.

3. Getting Started with Pipe Processors

The mrix Pipe Processor Template

The recommended way of building a pipe processor is to start with the mrix pipe processor template, commandtemplate.pl which you can find in \mrix\source\epoc\generic. You invoke this template with the intended name of the pipe processor from a DOS shell command line together with an appropriate UID2. The valid range of UIDs for development is 0x00000001-0x0fffffff. UIDs in this range should NOT be used for released code. Instead, third party developers will need to consult a Symbian technical paper. As an example, in order to create a template pipe processor, mrFoo with a development UID of 0x00f00f00, run the following command in the \mrix\source\epoc\generic directory:
commandtemplate.pl -n mrFoo -u 0x00f00f00 -s templates\synchronous_pp

On running this command you should find MSVC6 being launched with a skeleton project. Within that project you will find a ready made template mrFoo.html man page, empty todo.txt and history.txt files and also a number of C++ source and header files.

You should be able to compile and build the pipe processor both within MSVC6 and from a DOS shell command line. In order to build the pipe processor for a Symbian smartphone, you will first need to change directory from \mrix\source\epoc\generic to \mrix\source\epoc\generic\mrfoo\group. Now invoke the thumb variant build as follows:
abld build thumb urel
   and transfer the pipe processor to an appropriately connected target as follows:
putpp . mrfoo

Note that in order to do this you will need to ensure that an m-Router® connection is active between the Symbian smartphone and the PC and that the mrix remote shell daemon rshd is running.

Once the pipe processor mrFoo is on the device, it is necessary to modify the identity.ini file on the device to allow your identity to run this pipe processor because by default you will not be able to run it. This will require the addition of the following line to this file (under the appropriate user identity tag):
AllowmrFoo=YES

Following a reboot of the phone to ensure that the identity server is able to register the upgrade, you should be in a position to run the pipe processor.

The built-in help for mrFoo can be invoked as follows:
mrcmd . “mrfoo -h”

At this point, you have a mrFoo pipe processor running on the Symbian smartphone. You should be able to see it appear as a legitimate pipe processor in the mrmr -l listing of system pipe processors. Support for the following options is built in as default by the template:
-h: help listing
-v: verbose
-V: version

The process of getting from invoking the command template to having a working pipe processor installed on the system should take less than one minute.

Library Support

Pipe processors link to the following three libraries:
mStreamClientEx.lib: mStream classes
mStreamProcessorEx.lib: mrix pipe processor extensions.
mStreamUtilEx.lib: mrix pipe processor utilities.

The headers that correspond to these libraries are as follows:

| | |
|---|---|
| * | #include <mStreamClientEx.h> |
| * | #include <mStreamProcessorEx.h> |
| * | #include <mStreamUtilEx.h> |

Note that if you use the mrix pipe processor template, these libraries and headers will automatically be inserted into the relevant files, namely the .mmp make file and the stdafx.h header file.

4. Architectural Elements

Involving Other Pipe Processors

The following code snippet illustrates how to create an instance of a CPipeProcessorRunnerContainer and use it to determine the version of a pipe processor using the standard -V option:

runner=CPipeProcessorRunnerContainer::NewL( );
TInt handle = runner−>PPOpen(aPP,_L(“--version”));
Info(_L8(“PPOpen returned %d”),handle);
iVersionBuffer.SetLength(0);
if (handle > 0)

{// Synchronous read of PP output, until end of file
err=KErrNone;
while (!err)

{
TBuf8<8> buf;
err=runner−>PPRead(handle,&buf);
Info(_L8(“PPRead err=%d, \“%S\””),err,&buf);
if (!err)

iVersionBuffer+=buf;

}

err=runner−>PPClose(handle);
Info(_L8(“PPClose returned %d”),err);

delete runner;

5. Pipe Processor Design Patterns

There are four common types of processing that can occur within a pipe processor:
List Processing
Input Processing
Connection Management
State Management

Each of these architectural use cases can be handled using a specific pattern.

### APPENDIX 4

mrix Command and Script Guidelines

1. Introduction

This section lays down guidelines for how mrix commands (including both C++ pipe processors and scripts) should be written and how they should operate. It is intended for both the writers and testers of these commands.

2. Common to Pipe Processors and Scripts

The following guidelines apply to both pipe processors and scripts:

2.1 Input/Output Format

Data input or output by commands intended to be coming from or processed by other software should be accepted/available in at least one of the following formats:

MIME type Description Example
text/comma-separated-values List of records with fixed number of fields.
First record is header record.

mrps -L, mrouter -c list-devices

| | |
|---|---|
| text/x-mrix-versit | Tree or flat structure list of records with possibly |

varying number of fields.

mrcontacts −1, mragenda −1, mrmessage −1

| | |
|---|---|
| text/x-mrix-tagged | Static list of ‘label:value’ pairs, used where a single |
| output each time | static record is mrsim -i |

| application/octet-stream | Generic binary data, in command specific |
|---|---|
| | format |

mrfile -r, mrimage, mrtcp

2.2 Errors, Warnings and Information

All error, warning and information messages should by output on standard error, the aux output pipe. They should be in one of the following formats:

Format Usage

ERROR: Error message A fatal error which means operation of the command cannot continue. After outputting an ERROR message the command must stop immediately.

WARN: Warning message A diagnostic error which means something that the user should be alerted about has happened, but operation of the command can continue. Use sparingly.

INFO: Informationmessage A diagnostic message to help clients of your command while they are debugging their own software. Any messages used to debug your own command should be removed before releasing. INFO messages should only be output if the user has selected the VERBOSE command option. Use sparingly.

Special attention should be paid to any data output on standard error. You should never output more than 4K of data otherwise clients may deadlock unless they are reading both your output pipes simultaneously.

2.3 Return Value

A successful run of a command should result in a return value of zero. If an error occurs, the return value should be set to the appropriate (negative) error code.

2.4 Patterns

Your command should conform to one of the following patterns:

Type Description

Output only On execution the command does some processing based on the command line and outputs some data.

Input only On execution the command reads data either from standard input (until EOF), or a file, or the command line then processes it. No data is output.

Input then output On execution the command reads data either from standard input (until EOF), or a file, or the command line then processes it. Afterwards some data is output.

Watcher On execution the command runs and starts monitoring some system resource. Every time that resource changes, it will print ‘changed’ and a newline. The command will also read its input pipe. If the pipe is closed, or the text ‘quit’ is sent, then the watcher will exit.

Stream IO On execution the command will both read and write, according to some command specific rules.

2.5 Line Terminators

On output, all commands will terminate lines with a \r\n character pair. All commands which accept input in text format will understand lines which terminate either \r\n or \n.

2.6 Addressing Other Devices

If a command is required to address other devices then it should allow a number of different schemes for doing that. The scheme is applied by referring to the device as SCHEME:NAME. The default scheme is ANY if there is no scheme attached to the device reference.

Scheme Description

N If the command outputs a list of devices numbered from 1, then the N scheme allows a client to refer to a specific device in the list by its number in that list.

BTNAME References a device by its bluetooth name. It is the client's responsibility to ensure that the name is quoted and escaped as necessary.

BTADDR References a device by its bluetooth mac address. The command should understand the address with and without: delimiters.

IMEI References a device by its IMEI number.

ANY Tries to find a matching device by any of the above schemes.

2.7 Standard Options

All commands must support options in long (posix) and short forms and they must at least support the following options:

Option Description

-h, --help Display short usage text listing the command options and very brief explanation if there is room. The text output by -h should be no greater than 1024 bytes.

-V, --version Display version information in the following format: a.b.c (d) (e). a,b,c, d are the version and build number of mrix against which the command was built. e is a command specific version number which is incremented at every revision of the command.

-v, --verbose This command enables informational output about the command to be displayed. This information should be there solely for the benefit of finding problems in client programs, not debugging the command itself.

No option No command line options should cause the command to print an error and default to the help option.

In addition, many commands provide a --list, -l option as the primary inspection or display mechanism.

2.8 Additional Files

As well as the command itself, the developer should supply a html format man page to explain in detail the command's purpose and operation. The developer should also maintain a history.txt file (to record what has changed in each version of the command) and a todo.txt file (to record thoughts for upcoming versions).

2.9 Dependencies

Dependencies on other commands should be kept to a minimum. Core mrix commands may only depend on other core mrix commands. Commands designed to be re-used should only depend on core mrix commands.

3. Pipe Processors Only

The following guidelines apply to pipe processors only.

3.1 Memory Usage

All pipe processors should be written with an eye to minimising memory usage.

Objects should only be created if they are required by the command line used, e.g. running mrAgenda -V should not cause the command to connect to the Agenda server.

You should make good use of your 16 k stack available.

Use CBufFlat instead of large TBuf8's if you need to output large strings of data.

If you need to output more than 16 k of data, consider outputting asynchronously in chunks.

3.2 Outputting Data

Pipe processors should build up their data to be output in a single buffer, then output it—don't call WritePipeL over and over again.

3.3 International Support

Pipe processors should convert all UNICODE data to UTF8 before outputting it using the built in character conversion facilities of the platform.

4. Scripts Only

The following guidelines apply to scripts only.

4.1 Local

Make all your variables local

4.2 Error Codes

Make sure you always check the error codes of pipe processors you call.

Set your own error code as appropriate (we need to add a way of doing this)

4.3 Memory Usage

Process data a line at a time where possible, rather than slurping

4.4 Debugging

All scripts, even those designed to be run from other commands, should be runnable in a local context to allow for debugging.

### APPENDIX 5

mrix and the Smartphone Testing Environment

1. Summary

This section outlines a number of opportunities for employing mrix to assist Symbian OS smartphone manufacturers improve the quality and quantity of product testing. This testing is conducted during the long period of Symbian OS smartphone development that occurs prior to product shipment. The opportunities arise because of the overtly manual nature of the majority of testing done today.

2. Overview

2.1 Issues with Smartphone Testing Today

The testing of a Symbian OS smartphone during the long period of its development is a costly and painful exercise today. The process is heavily reliant on ad-hoc, manual and non-repeatable testing.

Issues with the Testing of Device Applications

Majority of tests are done manually
Long running tests and stress tests are almost impossible to do in an automated fashion
Data generation on the device is a painful and tedious exercise
Tests are not Readily Repeatable
Constant reflashing of ROMs during development cycle causes many of the more difficult or long-running tests to “fall through the cracks”
   Issues with the Testing of Connectivity Software
All the above issues apply equally to the testing of smartphone Connectivity software. In addition, because connectivity involves establishing a link between a PC and the smartphone, there is a further complication in that simultaneous control of the PC/Server and smartphone is not currently possible.
   2.3 The mrix Advantage

Smartphone device manufacturers' priorities in terms of product testing are as follows:
Smoke testing—testing basic UI functionality
Aging system tests—adding/removing/modifying entries thousands of times
Localisation testing—testing
Operator testing—phone network interoperability testing

In terms of the above list, mrix brings a vital additional element to the testing arena, namely the ability to remotely control potentially multiple Symbian OS devices. Remote control dramatically increases the scope for automation of testing and this in turn will be attractive to Symbian OS smartphone manufacturers because it should enable them to improve both the quality and quantity of testing while simultaneously reducing cost.

3. Potential Testing Opportunities for mrix

The following are concrete suggestions for prototypes that would help illustrate the advantages of using mrix as a basis for Symbian OS smartphone device testing. The suggestions are rated in terms of difficulty of implementation

3.1. Application Tester

Testing Symbian OS smartphone applications can be a laborious and difficult process. In addition, some smartphone manufacturers are already seeking to standardise the process of smartphone testing through the introduction of Developer Certification programs. There's a risk that a third party Symbian OS developers may become overwhelmed by the cost of all the certification. Ideally they'd like to have a cheap and easy way of sanity checking their application.

The Application Tester would automate the process of testing a Symbian OS application. This would require the implementation of screen validation support in mrix which could prove time-consuming but is probably essentially not only for the Application Tester but for many of the following opportunities. The support would probably involve implementing a pipe processor that is able to interact much more closely with Symbian OS wserv to allow a remote script to directly control input to an application and test its screen output. It would need to involve something similar to the Citrix protocol with GDI object information being passed over the mrix link. The current approach taken by mView involves passing screen bitmaps over the link.

3.2. Smoke Tester

Smoke testing probably gets repeated more than anything else during the testing phase. It is a crucial activity because it is the primary indicator used to determine whether a build is suitable for further beta testing. In other words they have a vital role as an early warning of regression. Today, smoke testing is almost exclusively manual. It usually takes the form of a tester enacting a range of appropriate use cases on the smartphone such as sending an email or browsing the web.

The mrix “Smoke Tester” would automate the whole smoke test procedure and indicate to a tester whether the build passed or failed. The tests could either be run from a script that used a variety of separate pre-existing pipe processors or they could encapsulated within a single pipe processor. In either case, the range of testing conducted for a typical smoke test should be enhanced to ensure that the barrier for acceptance for further testing is raised. In due course, there is no reason why the Smoke Tester might not be enhanced to evolve into a full blown system tester.

3.3. The Aging Stress Tester

Given that most smartphone testing is conducted manually, aging tests are particularly difficult to conduct. These involve simulate the use of the smartphone over an extended period of time. Smartphone manufacturers would be very interested in anything that could help them improve quality through aging tests because it could help them avoid very expensive product recalls.

The mrix “Aging Stress Tester” would simulate the process of aging by compressing for example 6 months of typical usage into a much smaller amount of time. This would include a whole range of user operations such as periodic insertion and occasional removal of contacts, agenda and email entries. The tests could be run using pre-existing pipe processors or by encapsulating them within a new stand-alone pipe processor. In either case, it should be easy to modify the tests that are run through a script.

3.4. The Test Code Harness

Symbian OS component test code is typically written in the form of a test harness that is frequently automated. As such, there is a fair amount that it should be possible to do in order to template such test code. In addition, moving component interface test code within a pipe processor raises the possibility of testing Symbian OS components entirely through scripting.

The mrix “Test Code Harness” would raise the game regarding component and interface testing. The harness would be in the form of a template pipe processor that could be filled in with the appropriate interface functions and then driven through a script interface. Once written, component test pipe processors as well as scripts could be combined to allow powerful system tests to be written.

3.5. Data Generator

Generating sample data on a smartphone today is a frustrating, limited and mainly manual procedure today. In particular, it is particularly difficult to generate varied data sets.

The Data Generator would automate the process of data generation by using either a stand-alone pipe processor or a combination of pipe processors to handle the device side work and a flexible script interface to vary the data set

3.6. Connectivity Tester

Testing smartphone connectivity is an inefficient and mainly manual procedure today. Symbian OS Smartphone manufacturers have traditionally really struggled with this area.

The Connectivity Tester would automate the process of testing the Symbian OS Connectivity conduits by integrating basic mrouter, contpro, backuppro and agendasync testing using a number of pipe processors and a set of test scripts.

3.7. Phone Network Stress Tester

In order to gain Network Operator approval, it is necessary for a smartphone to undergo extensive interoperability testing. It is our understanding that Symbian OS Smartphone manufacturers have traditionally struggled with gaining operator acceptance.

The Network Stress Tester would automate the process of testing against Network Operator acceptance criteria. It would consist of script support implemented against a set of pipe processors that would allow the testing of SMS, MMS and phone network functionality. This opportunity could initially be built upon Rob C's SMS tester script which already demonstrates the power and flexibility of mrix in testing in a multiple device context.

4. Related Opportunities for mrix

There are a number of areas closely related to testing which offer some good opportunities for Symbian OS smartphone manufacturers to deploy mrix technology. Specifically, field testing, diagnostics and debugging appear the most promising. Additional areas of interest could be IDE integration and the activity of product development itself.

4.1. Field Diagnostics Dumper

During field testing, it would be extremely useful for users to have a means of providing really comprehensive diagnostics from the smartphone under test to assist in defect triage and debugging.

The Field Diagnostics Dumper would be a pipe processor and small accompanying utility that could be used to provide quick and comprehensive diagnostics from the device under test.

4.2. IDE Integration

During pipe processor development, it has become clear that mrix has the potential to considerably speed up product development. The putpp utility alone has proved very handy for rapidly updating a pipe processor. There may be potential for partnering with an IDE tool vendor to develop a combined IDE with mrix inside that provides a more sophisticated development environment than is currently the case. It should be noted that this area has the potential to develop quite considerably but probably needs a lot more investment from us in terms of time and effort before it can do so.

1. Method of rapid software application development for a wireless mobile device, comprising the step of calling modular software elements, that each (i) encapsulate functionality required by the wireless mobile device and (ii) share a standard interface structure and (iii) execute on the device, under the control of a command line interface.

2. The method of claim 1 in which one or more modular software elements encapsulate device networking functions.

3. The method of claim 2 in which the device networking functionality relates to connectivity over one or more of the following: GPRS, 2G cellular, CDMA, WCDMA, Bluetooth, 802.11, infra-red, IP networking, dial up, modem; HSCSD and EDGE.

4. The method of claim 1 in which one or more of the modular software elements encapsulate general mobile device functionality.

5. The method of claim 4 in which the general mobile device functionality relates to one or more of the following: call control and handling; PIM functionality; SIM functionality; remote control, including screen scraping and faking key presses; monitoring, including processes, threads, memory and settings; UI, including creating an application where the screen elements are specified from a script; telephony, including monitoring and making calls; file system, including reading writing files and folders, monitoring for changes; database, including structured storage, retrieval, searching and monitoring of arbitrary application data; device personalization, including ringtones, wallpaper and settings.

6. The method of claim 1 in which the element under the control of a command line interface is a TCPIP interface which allows other programs on the device to be run upon receipt of an incoming connection or to make outgoing connections from the device under control of other device based programs.

7. The method of claim 1 in which the element under the control of a command line interface implements a remote command execution protocol.

8. The method of claim 1 in which the element under the control of a command line interface implements a scripting language that allows scripts to be written which use other programs on the device also controlled by a command line interface.

9. The method of claim 1 in which a high level language program runs on an application development computer remote from the device that can send instructions to the or each element on the device controlled by a command line interface.

10. The method of claim 9 in which the high level language program is a command line program that enables IP connections between the mobile device and a further program on the application development computer that implements the same remote command execution protocol as the device.

11. The method of claim 10 in which rapid application development is achieved by enabling device capabilities to be explored by executing the device-based elements controlled by a command line interface from a command prompt of the application development computer using the remote command execution protocol.

12. The method of claim 11 in which an output of each command is shown at the command prompt on the application development computer.

13. The method of claim 10 in which rapid application development is achieved by using scripts which combine the results of several device-based elements controlled by a command line interface in the scripting language written on the device.

14. The method of claim 13 in which the script is composed in a text editor running on the application development computer.

15. The method of claim 13 or 14 in which rapid application development is achieved by transferring the scripts to the device and executing them, again using the computer command prompt.

16. The method of claim 1 in which the standard interface structure of a modular software element is the name of the element, a set of command line options, two input streams and two output streams.

17. The method of claim 9 in which the high level language is not restricted to a single type of high level language, but can be any of the following depending on the requirements of the developer of the software application:
(a) a command line interface;
(b) a scripting language;
(c) a compiled language.

18. The method of claim 17 in which the application development computer is a desktop PC.

19. The method of claim 1 in which the high level language program can in addition run on the device, to enable re-programming of the device without the need to use a separate application development computer.

20. The method of claim 1 in which the modular software elements insulate the application developer from the specifics of the operating system of the device by requiring the application developer to understand the type of functionality to be deployed and not the specific operating specific code needed to implement that functionality using the operating system.

21. The method of claim 9 in which the device runs a command interpreter and the application development computer runs a command execution shell.

22. The method of claim 9 in which the application development computer is connected to the device over a local point to point IR, Bluetooth, USB, WAN, LAN, SMS or GPRS or any combination of these.

23. The method of claim 1 in which modular software elements can be chained together to build complex functionality.

24. The method of any preceding claim in which the modular software elements execute on the device in the context of an identity and associated permissions.

25. The method of claim 24 in which there is an identity server with secure permissions that provides and controls the identity and associated permissions.

26. The method of claim 25 in which the identity server is located on the device.

27. A software application developed using the method of any preceding claim 1-26.

28. The software application of claim 27 which is initiated or controlled from a remote application development computer.

29. The software application of claim 28 which is accessed or controlled by the remote application development computer in a secure fashion.

30. The software application of claim 27 which runs stand-alone on the device without any initiation or control from a remote application development computer.

31. Method of rapid software application development for a wireless mobile device, comprising the step of calling modular software elements, that each (i) encapsulate networking functionality required by the wireless mobile device and (ii) share a standard interface structure and (iii) execute on the device, using a high level language program.

32. The method of claim 31 in which the high level language is
(a) a command line interface; or
(b) a scripting language; or
(c) a compiled language.

33. The method of claim 31 or 32 further comprising the specific subject matter of any of preceding claims 1-26 .

34. The method of any preceding method claim in which the modular software elements execute on a CPU of the mobile device.
